(19) United States
(12) Patent Application Publication
(10) Pub. No.: US 2016/0025293 A1
(43) Pub. Date: Jan. 28, 2016

(54) LED LIGHTING ASSEMBLY FOR A SCHOOL BUS LAMP

(71) Applicant: Neng-Chen YEH, Tainan City (TW)

(72) Inventor: Neng-Chen YEH, Tainan City (TW)

(21) Appl. No.: 14/444,508

(22) Filed: Jul. 28, 2014

(51) Int. Cl. F21S 8/10; F21V 29/505; F21K 99/00

(52) U.S. Cl. CPC F21S 48/321; F21S 48/00; F21K 9/50; F21V 29/505

(57) ABSTRACT

An LED lighting assembly for a school bus lamp has a reflector and an LED module. The reflector has a base, a reflecting wing, and a connector. The reflecting wing is formed around the base. The connector is formed on the base. The LED module is mounted on the reflector and has at least one LED. The LED lighting assembly can be mounted on the seat of the school bus lamp by the connector and is covered with the lampshade of the school bus lamp. The LED lighting assembly can be directly mounted on the seat of the school bus lamp for reducing the replacement cost, and a lighting element of the school bus lamp is replaced by the LED lighting assembly. So the LED lighting assembly is suitable for the seat and the lampshade of the school bus lamps.

### BACKGROUND OF THE INVENTION

1. Field of the Invention

The present invention relates to an LED lighting assembly, and more particularly to an LED lighting assembly for a school bus lamp to reduce a replacement cost.

2. Description of Related Art

The standards of the school bus lamp are regulated strictly by law. With reference to FIG. 8, a school bus lamp has a seat 90, a lighting element 91, a reflector 92 and a lampshade 93. The seat 90 has a plate 94 and a connecting hole 95 formed through the plate 94. The lighting element 91 is mounted on the seat 90. The lighting element 91 has a body 96, a plug 97 and a wing 98. The plug 97 is mounted on the body 96 and inserted into the connecting hole 95 of the seat 90. The wing 98 is mounted around the plug 97. The reflector 92 is mounted on the seat 90 and has a through hole. The reflector 92 is connected to the wing 98 of the lighting element 91, and the lighting element 91 is inserted through the through hole. The lampshade 93 is mounted on the seat 90. The lampshade 93 has an inner surface, an outer surface, a first adjustment portion 931, a second adjustment portion 932 and a third adjustment portion 933. The inner surface faces the lighting element 91 and the reflector 92. The outer surface is opposite to the inner surface. The first adjustment portion 931 and the second adjustment portion 932 are mounted on the inner surface of the lampshade 93, and the second adjustment portion 932 is disposed around the first adjustment portion 931. The third adjustment portion 933 is mounted on the outer surface of the lampshade 93.

An LED (light emitting diode) is a point light source and has small volume and high luminance. Therefore, LED has been widely used in vehicle lamps. If the LED is substituted for the lighting element 91 of the school bus lamp, the seat 90, the reflector 92 and the lampshade 93 of the school bus lamp all need to be changed to comply with the regulations of the school bus lamp. Thus, the LED cannot be used in the school bus lamp directly, and the replacement cost of the school bus lamp is high.

To overcome the shortcomings, the present invention tends to provide an LED lighting assembly to mitigate or obviate the aforementioned problems.

### SUMMARY OF THE INVENTION

The main objective of the invention is to provide an LED lighting assembly to suit a seat and a lampshade of a school bus lamp for reducing the replacement cost.

The LED lighting assembly for a school bus lamp has a reflector and an LED module. The reflector has a base, a reflecting wing, and a connector. The base has a first surface and a second surface opposite to the first surface. The reflecting wing is formed around the base and has a reflecting surface and a rear surface opposite to the reflecting surface. The connector is formed on the second surface of the base. The LED module is mounted on the reflector and has a circuit board, a loading board and at least one LED. The circuit board is mounted on the rear surface of the reflecting wing. The loading board is mounted on the first surface of the base. The at least one LED is mounted on the loading board and is electrically connected to the circuit board.

The LED lighting assembly can be mounted on the seat of the conventional school bus lamp and is covered with the lampshade of the conventional school bus lamp. The connector of the reflector is inserted into a connecting hole of the seat. The light emitted from the LED module illuminates the reflecting surface of the reflecting wing and is reflected to the lampshade by the reflecting surface. Therefore, the LED lighting assembly can be directly mounted on the seat of the conventional school bus lamp for reducing the replacement cost, and a lighting element of the conventional school bus lamp is replaced by the LED lighting assembly. So the LED lighting assembly as described is suitable for the seat and the lampshade of a conventional school bus lamp.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an LED lighting assembly for a school bus lamp in accordance with the present invention;

FIG. 2 is another perspective view of the LED lighting assembly in FIG. 1;

FIG. 3 is an exploded perspective view of the LED lighting assembly in FIG. 1 mounted between a seat and a lampshade of a conventional school bus lamp;

FIG. 4 is an operational exploded perspective view of the LED lighting assembly in FIG. 3;

FIG. 5 is a side view in partial section of the lighting assembly in FIG. 4;

FIG. 6 is an exploded perspective view of the LED lighting assembly in FIG. 1 mounted between a seat and a lampshade of another conventional school bus lamp;

FIG. 7 is another exploded perspective view of the LED lighting assembly in FIG. 6; and

FIG. 8 is a side view in partial section of a school bus lamp in accordance with the prior art.

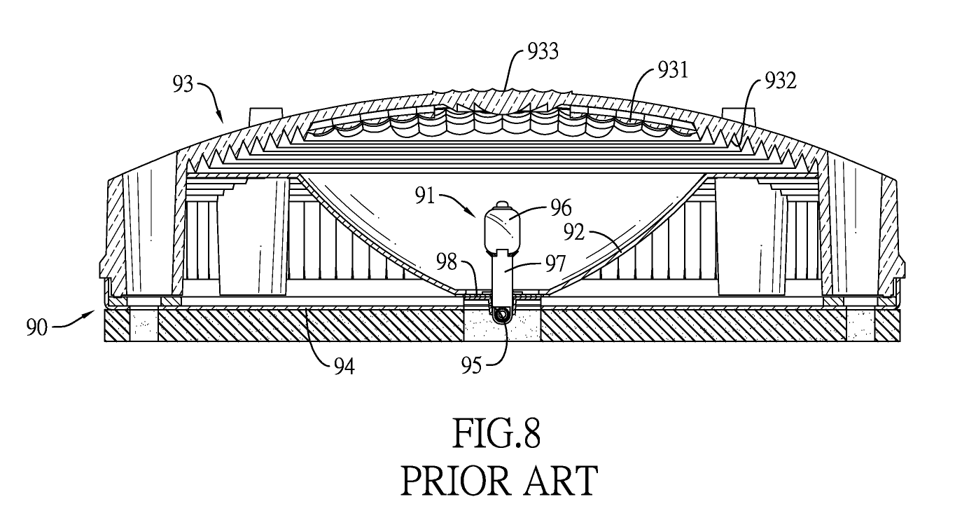

### DETAILED DESCRIPTION OF PREFERRED EMBODIMENT

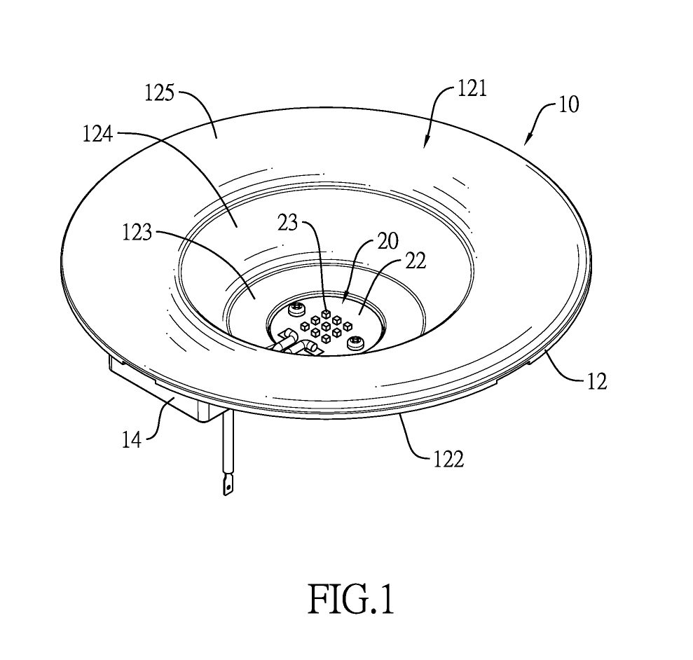

With reference to FIGS. 1, 2 and 5, an LED lighting assembly in accordance with the present invention comprises a reflector 10 and an LED module 20.

The reflector 10 has a base 11, a reflecting wing 12 and a connector 13. The base 11 has a first surface 111 and a second surface 112. The second surface 112 is opposite to the first surface 111. The reflecting wing 12 is formed around the base 11 and has a reflecting surface 121 and a rear surface 122. The rear surface 122 is opposite to the reflecting surface 121. The connector 13 is formed on the second surface 112 of the base 11.

The LED module 20 is mounted on the reflector 10 and has a circuit board 21, a loading board 22 and at least one LED 23. The circuit board 21 is mounted on the rear surface 122 of the reflecting wing 12. The loading board 22 is mounted on the first surface 111 of the base 11. The at least one LED 23 is mounted on the loading board 22 and is electrically connected to the circuit board 21.

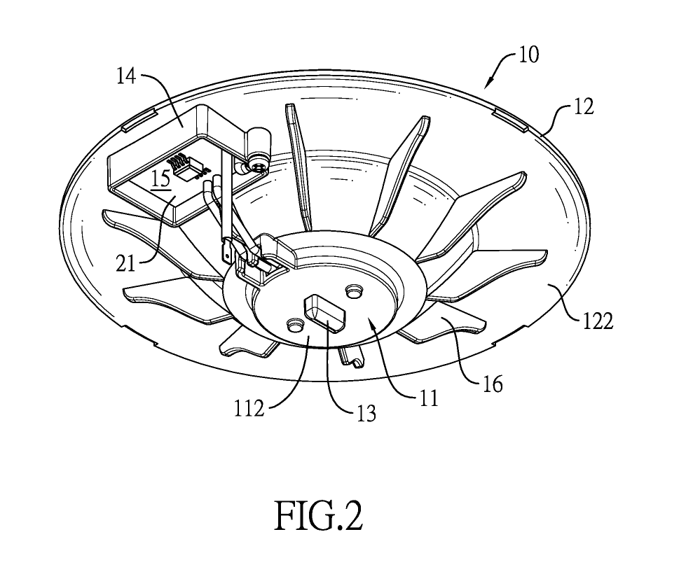

With reference to FIG. 2, the reflector 10 has a wall 14 and a chamber 15. The wall 14 is formed on the rear surface 122 of the reflecting wing 12. The chamber 15 is surrounded by the wall 14. The circuit board 21 is located in the chamber 15 of the reflector 10. Furthermore, the reflector 10 has multiple heat dissipating fins 16 mounted on the rear surface 122 of the reflecting wing 12.

With reference to FIG. 1, the reflecting surface 121 of the reflecting wing 12 has a first reflecting area 123, a second reflecting area 124 and a third reflecting area 125. The first reflecting area 123 is disposed around the base 11. The second reflecting area 124 is connected to and disposed around the first reflecting area 123. The third reflecting area 125 is connected to and disposed around the second reflecting area 124.

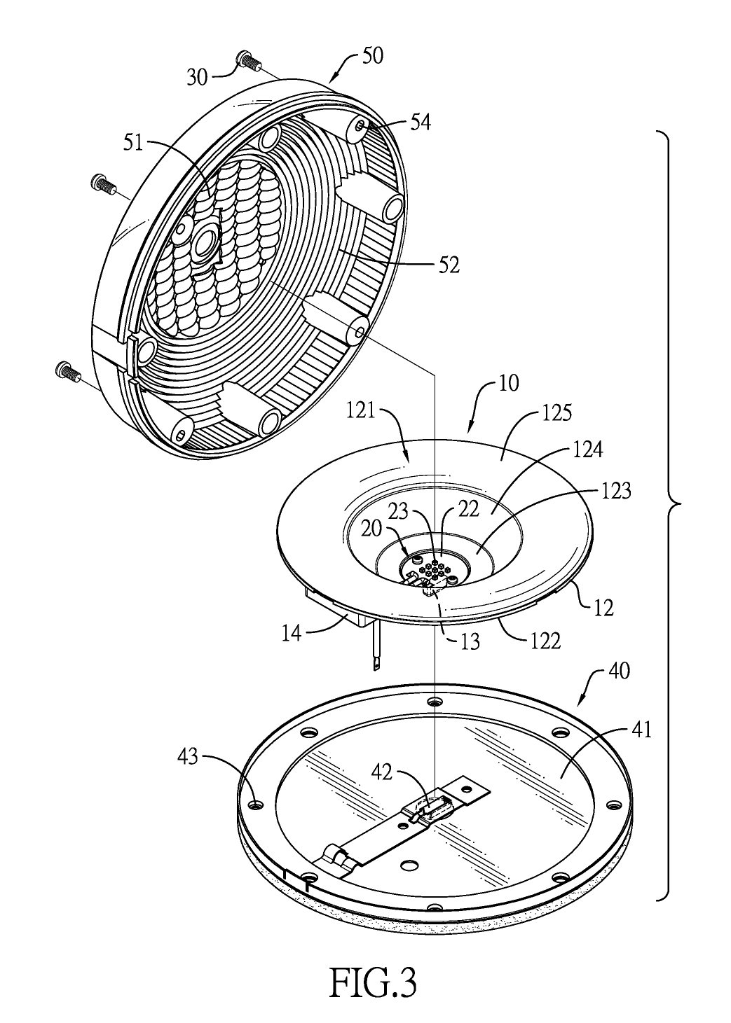

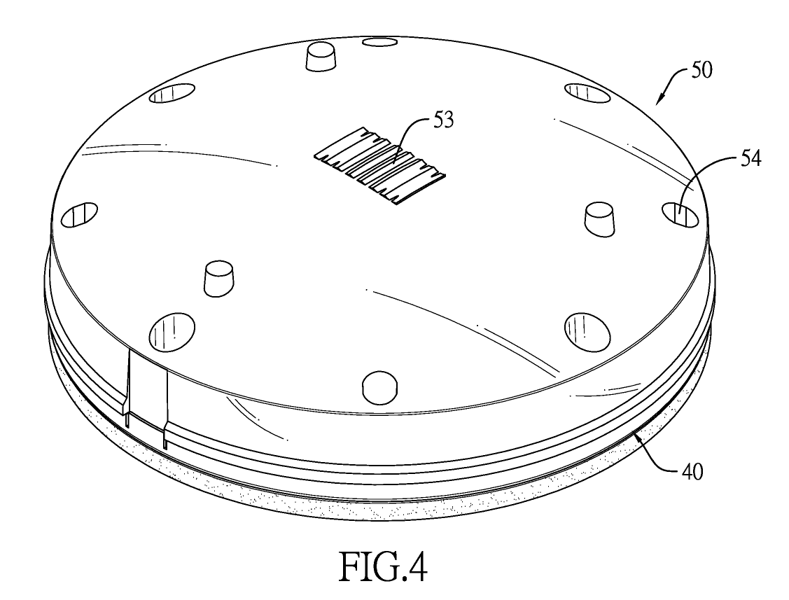

With reference to FIGS. 3 to 5, the LED lighting assembly is mounted on a seat 40 of a conventional school bus lamp and is covered with a lampshade 50 of the conventional school bus lamp. The seat 40 has a plate 41, a connecting hole 42 and multiple threaded holes 43. The connecting hole 42 and the threaded holes 43 are formed through the plate 41. The lampshade 50 is mounted on the seat 40. The lampshade 50 has an inner surface, an outer surface, a first adjustment portion 51, a second adjustment portion 52, a third adjustment portion 53 and multiple through holes 54. The inner surface faces the reflector 10. The outer surface is opposite to the inner surface. The first adjustment portion 51 and the second adjustment portion 52 are mounted on the inner surface of the lampshade 50, and the second adjustment portion 52 is disposed around the first adjustment portion 51. The third adjustment portion 53 is mounted on the outer surface of the lampshade 50. The through holes 54 are formed through the lampshade 50, and each through hole 54 is in communication with one of the threaded holes 43 to allow a screw 30 to be inserted.

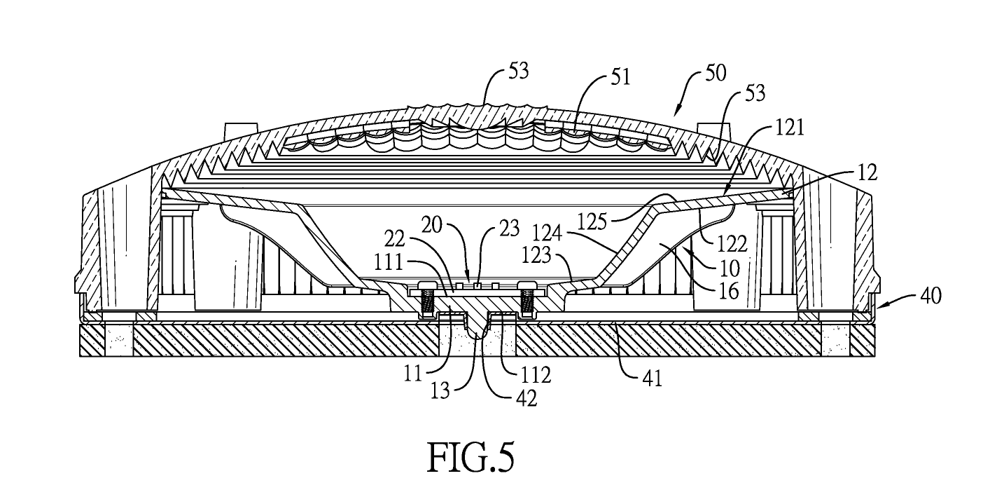

With reference to FIG. 5, the connector 13 of the reflector 10 is inserted into the connecting hole 42 of the seat 40. The reflecting surface 121 of the reflecting wing 12 faces the inner surface of the lampshade 50. The first reflecting area 123 and the second reflecting area 124 of the reflecting wing 12 face the first adjustment portion 51 of the lampshade 50. The third reflecting area 125 of the reflecting wing 12 faces the second adjustment portion 52 of the lampshade 50. The light emitted from the LED module 20 illuminates the reflecting surface 121 of the reflecting wing 12 and is reflected to the lampshade 50 by the reflecting surface 121.

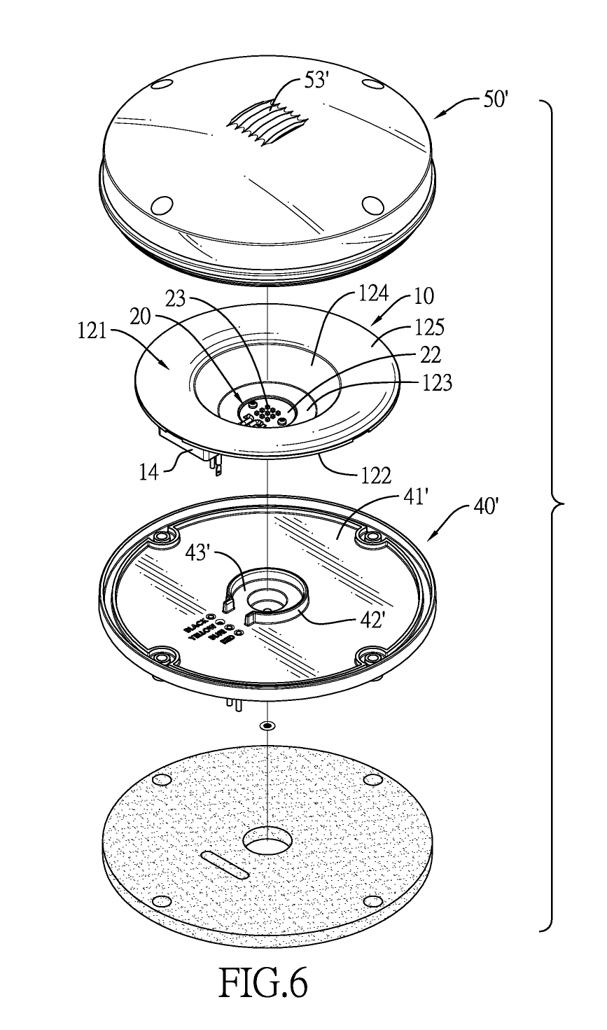

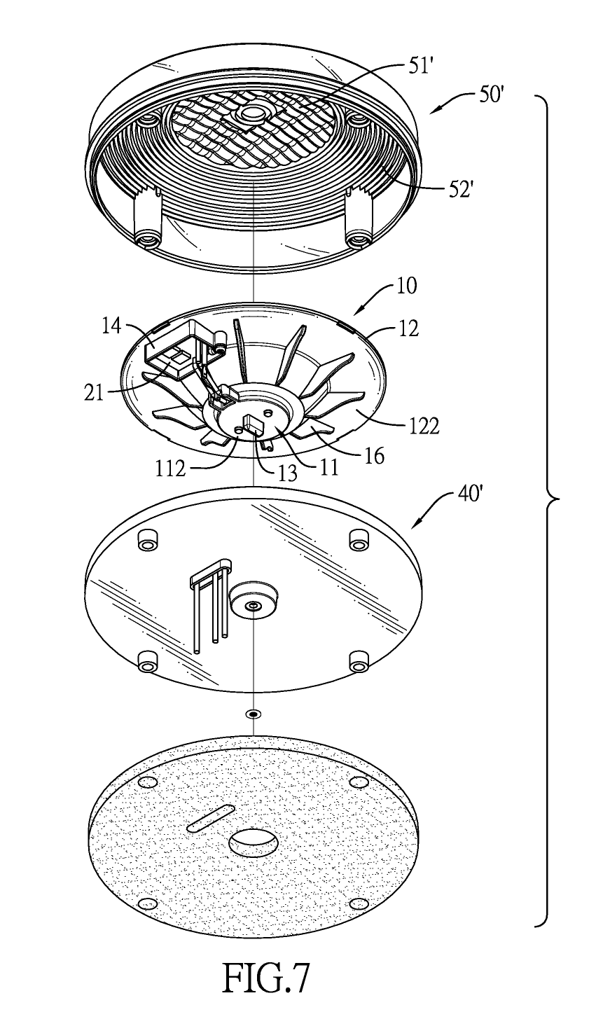

With reference to FIGS. 6 to 7, the LED lighting assembly is mounted on a seat 40′ of another conventional school bus lamp and is covered with a lampshade 50′ of the conventional school bus lamp. The seat 40′ has a plate 41′, a protrusion 42′ and a recess 43′. The protrusion 42′ and the recess 43′ are formed on the plate 41′. The protrusion 42′ is formed around the recess 43′. The lampshade 50′ is mounted on the seat 40′. The lampshade 50′ has an inner surface, an outer surface, a first adjustment portion 51′, a second adjustment portion 52′ and a third adjustment portion 53′. The inner surface faces the reflector 10. The outer surface is opposite to the inner surface. The first adjustment portion 51′ and the second adjustment portion 52′ are mounted on the inner surface of the lampshade 50′, and the second adjustment portion 52′ is disposed around the first adjustment portion 51′. The third adjustment portion 53′ is mounted on the outer surface of the lampshade 50′. The base 11 of the reflector 10 is inserted into the recess 43′ of the seat 40′. The reflecting surface 121 of the reflecting wing 12 faces the inner surface of the lampshade 50′. The first reflecting area 123 and the second reflecting area 124 of the reflecting wing 12 face the first adjustment portion 51′ of the lampshade 50′. The third reflecting area 125 of the reflecting wing 12 faces the second adjustment portion 52′ of the lampshade 50′. The light emitted from the LED module 20 illuminates the reflecting surface 121 of the reflecting wing 12 and is reflected to the lampshade 50′ by the reflecting surface 121.

Accordingly, the LED lighting assembly can be directly mounted on the seat 40 of the conventional school bus lamp for reducing the replacement cost, and a lighting element of the conventional school bus lamp is replaced by the LED lighting assembly. Therefore, the LED lighting assembly is suitable for the seat 40,40′ and the lampshade 50,50′ of the conventional school bus lamps.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED lighting assembly for a school bus lamp comprising:
a reflector having
a base having
a first surface; and
a second surface opposite to the first surface;
a reflecting wing formed around the base and having
a reflecting surface;
a rear surface opposite to the reflecting surface;
a connector formed on the second surface of the base; and
an LED module mounted on the reflector and having
a circuit board mounted on the rear surface of the reflecting wing;
a loading board mounted on the first surface of the base; and
at least one LED mounted on the loading board and electrically connected to the circuit board.

2. The LED lighting assembly as claimed in claim 1, wherein
the reflector has
a wall formed on the rear surface of the reflecting wing; and
a chamber surrounded by the wall; and
the circuit board is located in the chamber of the reflector.

3. The LED lighting assembly as claimed in claim 1, wherein the reflector has multiple heat dissipating fins mounted on the rear surface of the reflecting wing.

4. The LED lighting assembly as claimed in claim 2, wherein the reflector has multiple heat dissipating fins mounted on the rear surface of the reflecting wing.

5. The LED lighting assembly as claimed in claim 1, wherein
the reflecting surface of the reflecting wing has
a first reflecting area disposed around the base;
a second reflecting area connected to and disposed around the first reflecting area; and
a third reflecting area connected to and disposed around the second reflecting area.

6. The LED lighting assembly as claimed in claim 2, wherein
the reflecting surface of the reflecting wing has
a first reflecting area disposed around the base;
a second reflecting area connected to and disposed around the first reflecting area; and
a third reflecting area connected to and disposed around the second reflecting area.

7. The LED lighting assembly as claimed in claim 3, wherein
the reflecting surface of the reflecting wing has
a first reflecting area disposed around the base;
a second reflecting area connected to and disposed around the first reflecting area; and
a third reflecting area connected to and disposed around the second reflecting area.

8. The LED lighting assembly as claimed in claim 4, wherein
the reflecting surface of the reflecting wing has
a first reflecting area disposed around the base;
a second reflecting area connected to and disposed around the first reflecting area; and
a third reflecting area connected to and disposed around the second reflecting area.
